(19) United States
(12) Patent Application Publication
(10) Pub. No.: US 2026/0139520 A1
(43) Pub. Date: May 21, 2026

(54) Hand Restraint System

(71) Applicant: Michael Bryan, Greenville, SC (US)

(72) Inventor: Michael Bryan, Greenville, SC (US)

(21) Appl. No.: 18/950,800

(22) Filed: Nov. 18, 2024

(51) Int. Cl. E05B 75/00

(52) U.S. Cl. CPC E05B 75/00

(57) ABSTRACT

A hand restraint system includes an elongated member and three handcuffs. A first handcuff of the three handcuffs is mounted to the elongated member at a first end portion of the elongated member, a second handcuff of the three handcuffs is mounted to the elongated member at a second end portion of the elongated member, and a third handcuff of the three handcuffs mounted to the elongated member at the second end portion of the elongated member.

### FIELD OF THE INVENTION

The present subject matter relates generally to hand restraint systems or handcuffs.

### BACKGROUND OF THE INVENTION

Law enforcement personnel frequently use handcuffs to secure an individual's wrists together. The handcuffs are locked on the individual's wrists and cannot be removed without a key. When secured together with handcuffs, an individual cannot move his or her wrists more than a few inches apart, making many tasks difficult or impossible. Law enforcement personnel can more easily and/or confidently control a handcuffed individual due to such restricted movement.

Known handcuffs generally work well to secure the individual's wrists when the individual's wrists are placed close together behind the individual's back. However, known handcuffs have drawbacks. For instance, an individual may be uncooperative such that properly positioning the individual's wrists for securement by handcuffs is difficult. The individual may be lying face down with his or her wrists located below his or her chest. In such a position, moving the individual's wrists to the proper location for securing with the known handcuffs can be extremely difficult and require law enforcement personnel to pry the individual's arms from beneath his or her chest, a tiresome, and potentially dangerous, situation.

### BRIEF DESCRIPTION OF THE INVENTION

Aspects and advantages of the invention will be set forth in part in the following description, or may be apparent from the description, or may be learned through practice of the invention.

In an example embodiment, a hand restraint system includes an elongated member extending between a first end portion and a second end portion. The elongated member includes a first handle and a second handle. The first handle is disposed at the first end portion of the elongated member. The second handle is disposed at the second end portion of the elongated member. a buckle mounted on the elongated member between the first and second end portions of the elongated member. A first handcuff is mounted to the elongated member at the first end portion of the elongated member. A second handcuff is mounted to the buckle. The buckle is coupled to the elongated member such that a length of the elongated member between the first and second handcuffs is adjustable.

In another example embodiment, a hand restraint system includes an elongated member extending between a first end portion and a second end portion. The elongated member includes a handle at the second end portion of the elongated member. A buckle is movably mounted on the elongated member. The buckle is adjustable between an engaged configuration and a disengaged configuration. The buckle blocks retraction of the elongated member in one direction when the buckle is in the engaged configuration. The elongated member is retractable through the buckle in the one direction when the buckle is in the disengaged configuration. A first handcuff is mounted to the elongated member at the first end portion of the elongated member. A second handcuff is mounted to the buckle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a top plan view of a hand restraint system according to an example embodiment of the present subject matter and with a buckle of the example hand restraint system shown in a fully extended position.

FIG. 2 is another top plan view of the example hand restraint system of FIG. 1 with the buckle shown a partially retracted position.

FIG. 3 is another top plan view of the example hand restraint system of FIG. 1 with the buckle shown a retracted position.

FIG. 4 is a top plan view of the buckle of FIG. 1.

FIG. 5 is a top plan view of the buckle of FIG. 4 with a key shown engaged with the buckle.

FIG. 6 is a top plan view of a buckle according to another example embodiment of the present subject matter.

FIG. 7 is a partially exploded view of the example buckle of FIG. 6.

FIG. 8 is a top plan view of the example restraint system of FIG. 1 secured to a hand.

Repeat use of reference characters in the present specification and drawing is intended to represent the same or analogous features or elements of example aspects of the present invention.

### DETAILED DESCRIPTION

The present subject matter generally provides a hand restraint system that provides flexibility with regards to securing the hands of individuals.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

When introducing elements of the present disclosure or the preferred embodiment(s) thereof, the articles “a”, “an”, “the” and “said” are intended to mean that there are one or more of the elements. As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

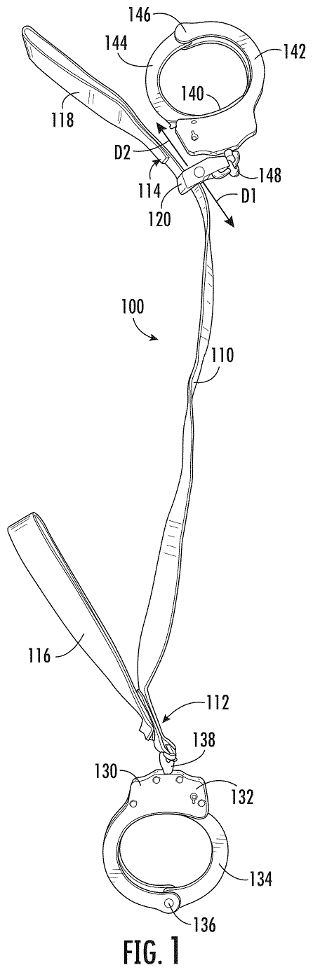

FIG. 1 is a top plan view of a hand restraint system 100 according to an example embodiment of the present subject matter. The hand restraint system 100 is configured for securing the wrists of an individual. For instance, a law enforcement official may utilize the hand restraint system 100 to assist with an arrest or detention of the individual. The hand restraint system 100 may also be referred to as handcuffs. As discussed in greater detail below, the hand restraint system 100 may advantageously provide various options for applying the hand restraint system 100 to wrists of the individual. Thus, the hand restraint system 100 may provide a flexible system for controlling and securing an individual's wrists.

As shown in FIG. 1, the hand restraint system 100 includes an elongated member 110, a buckle 120, a first handcuff 130, and a second handcuff 140. The elongated member 110 may extend, e.g., longitudinally, between a first end portion 112 and a second end portion 114. The first handcuff 130 may be mounted to the elongated member 110, e.g., at the first end portion 112 of the elongated member 110. The second handcuff 130 may be mounted to the buckle 120. The buckle 120 may be movable on the elongated member 110 as discussed in greater detail below.

The elongated member 110 may be a connector for the first and second handcuffs 130, 140. For instance, the elongated member 110 may be a fabric webbing as shown in FIG. 1. In alternative example embodiments, the elongated member 110 may be a cable or other suitable elongated member. The elongated member 110 may securely and reliably connect the first and second handcuffs 130, 140. In addition, because the elongated member 110 is flexible, elongated member 110 may advantageously coil for storage, e.g., within a handcuff holder on a belt of a law enforcement official.

The first and second handcuffs 130, 140 may each be applied or positioned on a respective wrist of an individual. For instance, a law enforcement official may lock first handcuff 130 on one wrist of the individual and lock second handcuff 140 on the other wrist of the individual. The elongated member 110 may couple or connect first and second handcuffs 130, 140. For instance, the elongated member 110 may limit a distance by which first handcuff 130 may move relative to second handcuff 140. Thus, when the hand restraint system 100 is applied to the individual, movement of the individual's wrists may be limited by the elongated member 110 connecting the first and second handcuffs 130, 140. As described in greater detail below, a length of the elongated member 110 between the first and second handcuffs 130, 140 may be adjusted using the buckle 120.

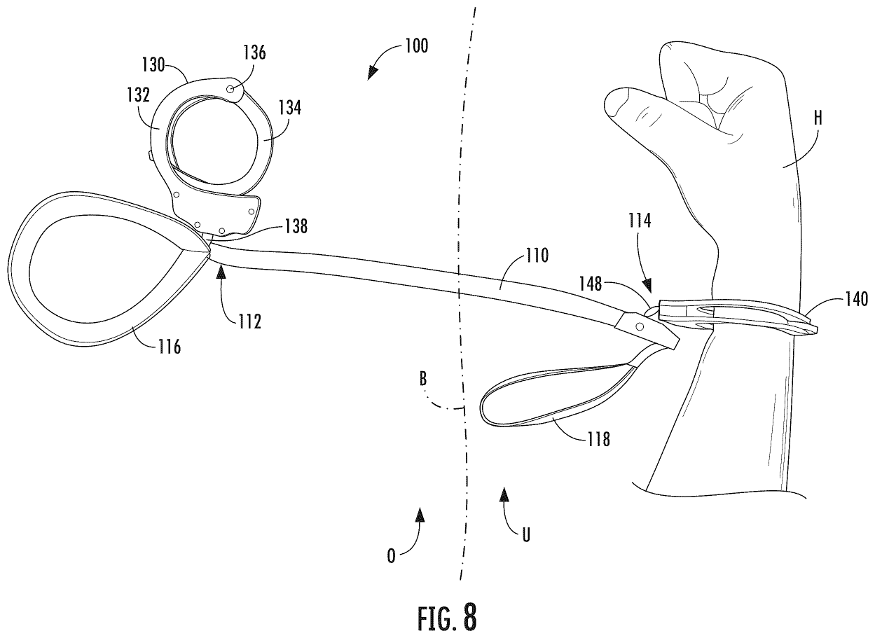

The hand restraint system 100 includes features for assisting with moving the wrists of the individual, for instance from below the individual when the individual is lying facedown on the ground with his or her wrists positioned under the individual. Such features are described in greater detail below in the context of FIG. 8, which is top plan view of the hand restraint system 100 with second handcuff 140 positioned on a wrist of an individual below a body B of the individual and with first handcuff 130 not positioned below the body B of the individual.

When the individual with body B is lying facedown with a hand H positioned beneath the body B, i.e., on the underside U of the body B, moving the hand H from the underside U of the body B can be difficult for the law enforcement official. In particular, the law enforcement official may have difficulty with simultaneously grasping the hand H and getting leverage to pull the hand H from the underside U of the body B to the outside O of the body B, i.e., to a position where the hand H is not located beneath the body B. It can be particularly difficult and/or potentially dangerous for the law enforcement official to remove the individual's hand(s) from below the body B and reposition the hand(s) on the individual's back where conventional handcuffs can restrain the individual's hand(s).

To assist in the above and similar situations, the hand restraint system 100 includes a first handle 116 and a second handle 118. The first handle 116 may be positioned at or adjacent the first end portion 112 of the elongated member 110, e.g., and the first handcuff 130. Conversely, the second handle 118 may be positioned at or adjacent the second end portion 114 of the elongated member 110. Thus, each of the first and second handles 116, 118 may be positioned at or adjacent a respective one of the first and second end portions 112, 114 of the elongated member 110. Moreover, the first and second handles 116, 118 may be positioned opposite each other on the elongated member 110. A law enforcement official may pull on one of first and second handles 116, 118 in order to assist with moving a wrist of secured by an opposite one of first and second handcuffs 130, 140, as discussed in greater detail below.

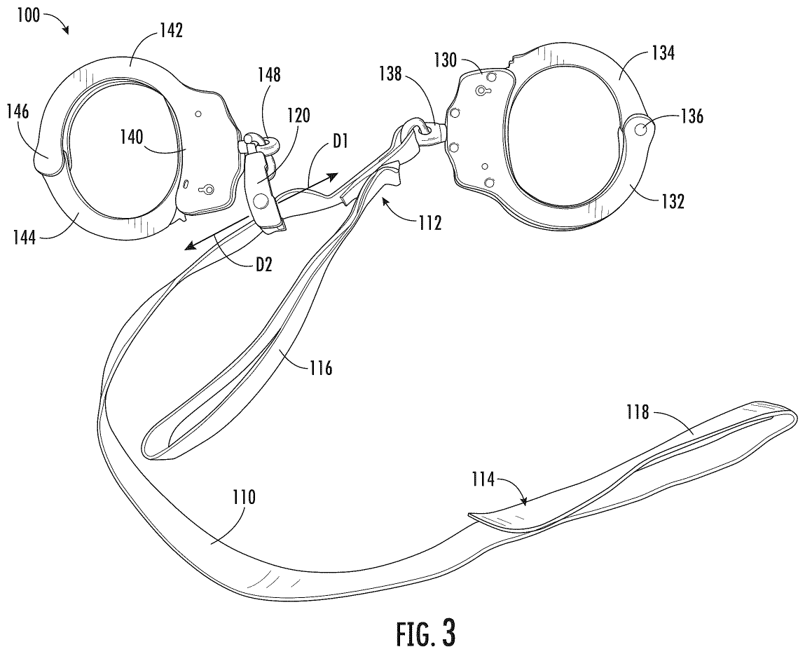

As shown in FIG. 3, an individual with body B may be lying facedown with hand H positioned beneath the body B, i.e., on the underside U of the body B. To secure the hand H behind the back of the body B, a law enforcement official may use the hand restraint system 100 to safely and/or quickly move the hand H from the underside U of the body B.

First, the law enforcement official may secure one of first and second handcuffs 130, 140 to the hand H (the second handcuff 140 in FIG. 8). Next, the law enforcement official may grasp the respective one of first and second handles 116, 118 (the first handle 116 in FIG. 8). In FIG. 8, due to the elongated member 110, the first handle 116 may be conveniently located to the outside O of the body B where the law enforcement official can quickly and easily grasp the first handle 116. When the law enforcement official pulls on the first handle 116, the elongated member 110 transfers the force applied by the law enforcement official to the second handcuff 140. The law enforcement official may move the hand H from the underside U of the body B to outside O of the body B by applying sufficient force. Once the hand H is out from the underside U of the body B, the law enforcement official may secure the hand H behind the back of the individual using the first and second handcuffs 130, 140.

Without the hand restraint system 100, the law enforcement official would generally be required to grasp the individual's wrist below the body B and with great exertion wrestle the hand H from the underside U of the body B to outside O of the body B while constantly grasping the individual's wrist. The hand restraint system 100 provides the law enforcement official with a convenient place to grasp and allows the law enforcement official to apply the required force to move the hand H more easily and/or with greater leverage.

The first handle 116 may be a first loop handle as shown in FIGS. 1 through 3. Thus, the first handle 116 may include a loop of material, such as the webbing of the elongated member 110. The loop of material used to form the first handle 116 may sized such that a hand of a law enforcement official may be inserted through the loop. In such a manner, the law enforcement official may advantageously grasp the first handle 116 securely and/or quickly. The loop of material may be mounted to the first handcuff 130 or to the elongated member 110 proximate the first end portion 112 of elongated member 110. For instance, the loop of material may extend through a swivel 138 of the first handcuff 130. The first handcuff 130 may be fixed relative to the first handle 116, and the second handcuff 140 may be movable relative to the first handle 116.

The elongated member 110 may have a length between the first and second end portions 112, 114 of the elongated member 110. The length of the elongated member 110 between the first and second end portions 112, 114 of the elongated member 110 may be selected to provide various options for applying the hand restraint system 100 to wrists of the individual and other functions. For instance, the length of the elongated member 110 between the first and second end portions 112, 114 may be no less than eight inches (8″) and no more than sixteen inches (16″). Such sizing of the elongated member 110 may advantageously allow use of the restraint system 100 to secure wrists of an individual together and remove the hands of an individual from below his or her body as described above. In addition, such sizing of the elongated member 110 may advantageously allow storage of the hand restraint system 100, e.g., within a handcuff holder on a belt of the law enforcement official when the elongated member 110 is coiled. In contrast, leg irons and other large restraints are generally not carried on the belt of the law enforcement official due to the onerous size, weight, etc. of leg irons and large restraints.

The first and second handcuffs 130, 140 may be any suitable handcuffs. Thus, the operation and construction of the first and second handcuffs 130, 140 is not described in greater detail herein for the sake of brevity. However, as shown in FIGS. 1, 2, and 3, the first handcuff 130 may generally include a first strand 132 rotatably mounted to a second strand 134 with a hinge 136. When the first handcuff 130 is open, the first strand 132 may be rotated relative to the second strand 134 on the hinge 136 such that an opening is formed between first and second strands 132, 134 and an interior of the first handcuff 130 is open. Thus, a wrist of an individual may be inserted through the opening between the first and second strands 132, 134 into the interior of the first handcuff 130 when the first handcuff 130 is open. Conversely, as shown in FIGS. 1-3, when the first handcuff 130 is closed, the first strand 132 may be rotated relative to the second strand 134 such that the first and second strands 132, 134 overlap and the interior of first handcuff 130 is closed. Thus, the wrist of the individual between the first and second strands 132, 134 within the interior of the first handcuff 130 may be held by the first handcuff 130 due to interference with the first and second strands 132, 134 when the first handcuff 130 is closed.

When the first handcuff 130 is closed, rotation of first and second strands 132, 134 towards the open configuration of the first handcuff 130 may be prevented by a lock within the first handcuff 130. For instance, ratchet teeth on the first strand 132 may engage a locking pawl (not shown) within the second strand 134 to prevent retraction of the first strand 132 from the second strand 134. A key may be used to release the locking pawl and allow the first handcuff 130 to open.

The first handcuff 130 may also include a swivel 138. When the elongated member 110 is a fabric webbing as shown in FIG. 1, an end of the elongated member 110 may be wrapped around the swivel 138 and/or a link connected to the swivel 138 and stitched to another section of the elongated member 110 in order to couple the first handcuff 130 to the elongated member 110. The first handcuff 130 may be rotatable relative to the elongated member 110 via the swivel 138.

The second handcuff 140 may be constructed in the same or similar manner to the first handcuff 130. Thus, the description of the first handcuff 130 above is equally applicable to the second handcuff 140, and repetitive description of the second handcuff 140 is omitted for the sake of brevity. For example, the second handcuff 140 may have a first strand 142 and a second strand 144. The second handcuff 140 may be rotatable relative to the elongated member 110 via a swivel 148.

The second handcuff 140 may be mounted to the buckle 120. For instance, the first strand 142 of the second handcuff 140 may be attached to the buckle 120. Moreover, the buckle 120 may be attached to the first strand 142 of the second handcuff 140 at the swivel 148 of the second handcuff 140. In example embodiments, a link connected to the swivel 148 may extend between and connect the second handcuff 140 to the buckle 120. The second handcuff 140 may be rotatable relative to the elongated member 110 on the buckle 120 via the swivel 148.

The hand restraint system 100 may include only two handcuffs, namely the first and second handcuffs 130, 140. Thus, only the first and second handcuffs 130, 140 may be mounted to the elongated member 110, and no third handcuff may be mounted to the elongated member 110 in the hand restraint system 100 such that the hand restraint system 100 includes exactly two (and no more) handcuffs. Thus, e.g., the hand restraint system 100 may not be suitable for prison transfer, may not include a belt, may not include a belly chain, may not include leg cuffs, etc. As may be seen from the above, the hand restraint system 100 may be a simple system that includes the elongated member 110, the buckle 120, the first handcuff 130, and the second handcuff 140 and no or limited additional components.

The buckle 120 may be mounted on the elongated member 110, e.g., between the first and second end portions 112, 114 of the elongated member 110. The buckle 120 may thread onto the elongated member 110 such that a length of the elongated member 110 between the first and second handcuffs 130, 140 is adjustable. For instance, the buckle 120 may be selectively blocked from sliding in one direction (that is shown with arrow D1 in FIGS. 1 through 3) on the elongated member 110, and the buckle 120 may be freely slidable in the other direction (that is opposite to the one direction, and that is shown with arrow D2 in FIGS. 1 through 3) on the elongated member 110. Thus, the buckle 120 may be selective one-way buckle for adjusting the length of the elongated member 110 between the first and second handcuffs 130, 140. Moreover, the buckle 120 may be adjustable between an engaged configuration and a disengaged configuration. The buckle 120 may block retraction of the elongated member 110 in the one direction D1 when the buckle 120 is in the engaged configuration, the elongated member 110 may be retractable through the buckle 120 in the one direction D1 when the buckle 120 is in the disengaged configuration.

The buckle 120 may be a mechanism for selectively adjusting the length of the elongated member 110 between the first and second handcuffs 130, 140. For example, the buckle 120 may include a cam buckle, a ratchet buckle, a push-button buckle, a tongueless buckle, etc. Other buckles that allow for selectively adjusting the length of the elongated member 110 between the first and second handcuffs 130, 140 are also within the scope of the present description.

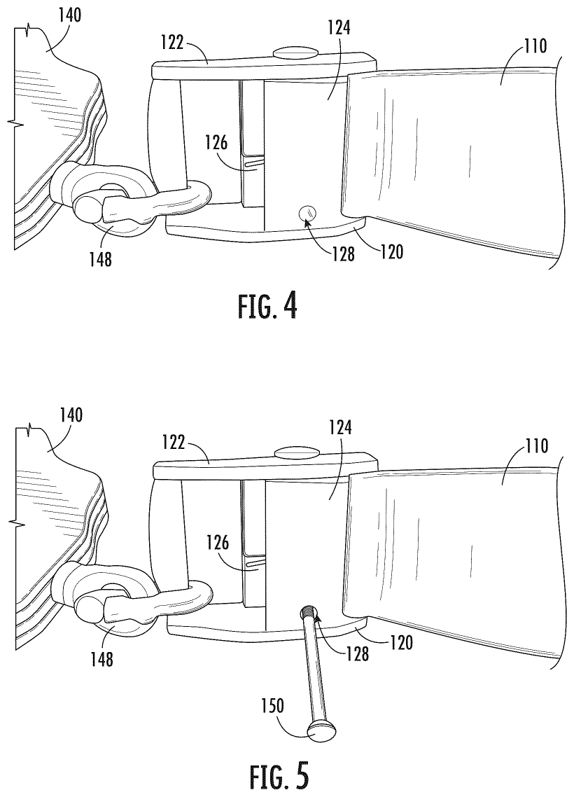

With reference to FIGS. 4 and 5, the buckle 120 may be a cam buckle. The cam buckle 120 may include a casing 122, a lever 124, and a spring 126. The elongated member 110 may be threaded through the casing 122. The spring 126 may urge the lever 124 against the elongated member 110, and a knurled surface of the lever 124 may engage the elongated member 110 against the casing 122 to limit retraction of the elongated member 110 in the one direction D1 (FIG. 1). The spring 126 may urge the lever 124 towards the casing 122 such that the buckle 120 is normally in the engaged configuration. The lever 124 may not include an integrated tab/handle for manually adjusting the lever 124 away from the elongated member 110. In the example embodiment, shown in FIGS. 4 and 5, the cam buckle 120 may include a keyhole 128, and a key 150 (FIG. 5) may be inserted into the keyhole 128. A user may push against the key 150 in the keyhole 128 in order to rotate the lever 124 and shift the cam buckle 120 from the engaged configuration into the disengaged configuration against the spring 126. The cam buckle 120 may return to the disengaged configuration back to the engaged configuration due to the spring 126 urging the lever 124 towards the casing 122.

The cam buckle 120 may be configured to releasably engage the elongated member 110. Moreover, the cam buckle 120 may block retraction of the elongated member 110 through the cam buckle 120 in the one direction D1. In addition, the cam buckle 120 may be configured such that increasing of the length of the elongated member 110 between the first and second handcuffs 130, 140 is blocked when the cam buckle 120 engages the elongated member 110. The cam buckle 120 may be configured such that the elongated member 110 is freely movable through the cam buckle 120 in the other direction D2 that is opposite the one direction D1 in order to decrease the length of the elongated member 110 between the first and second handcuffs 130, 140 when the cam buckle 120 engages the elongated member 110 (e.g., in both the engaged and disengaged configurations).

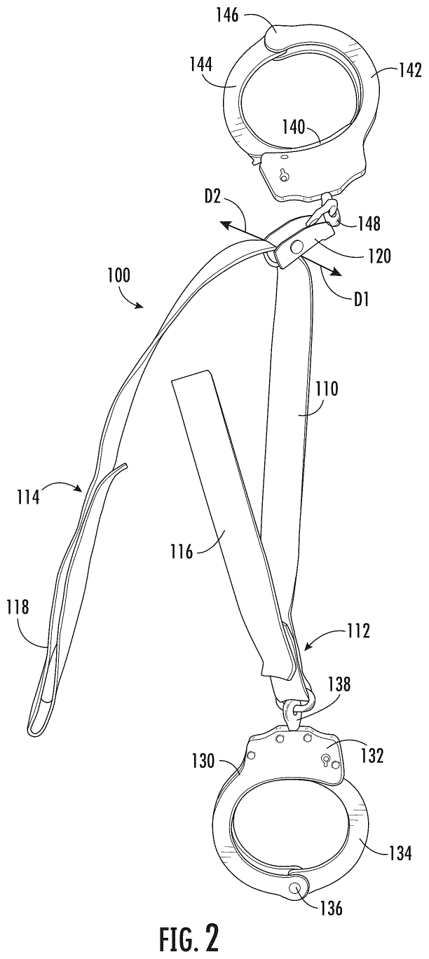

Turning back to FIGS. 1 through 3, operation of the hand restraint system 100 to adjust the length of the elongated member 110 between the first and second handcuffs 130, 140 using the buckle 120 will now be described in greater detail below. Starting from FIG. 1, the length of the elongated member 110 between the first and second handcuffs 130, 140 may be fully extended. Such arrangement may assist with removing a hand of an individual from beneath a body of the individual as described above. Both hands of the individual may then be secured with the first and second handcuffs 130, 140. Moreover, a law enforcement official may secure each of the first and second handcuffs 130, 140 on a respective wrist of the individual. The length of the elongated member 110 between the first and second handcuffs 130, 140 may be greater than desired for safely restraining and/or transporting the individual. Thus, the law enforcement official may reduce the length of the elongated member 110 between the first and second handcuffs 130, 140 by pulling on the second handle 118 in order to pull the elongated member 110 through the buckle 120 along the other direction D2 until the hand restraint system 100 adjusts to the arrangement shown in FIG. 2, in which the hand restraint system 100 is shown in a partially retracted position. For larger individuals, the partially retracted position may be a suitable length of the elongated member 110 between the first and second handcuffs 130, 140 to secure such individuals. Alternatively, the law enforcement official may continue to pull on the second handle 118 and further move the elongated member 110 through the buckle 120 along the other direction D2 in order to further reduce the length of the elongated member 110 between the first and second handcuffs 130, 140 as shown in FIG. 3, in which the hand restraint system 100 is shown in a retracted position.

As noted above, the buckle 120 may be normally in the engaged configuration. Thus, the buckle 120 may normally block retraction of the elongated member 110 in the one direction D1 such that the individual secured by the first and second handcuffs 130, 140 may not be able to move his or her hands further apart than the length of the elongated member 110 between the first and second handcuffs 130, 140 selected by the law enforcement official. After removing the hand restraint system 100 from the individual and/or to allow for greater comfort for the individual, the law enforcement official may adjust the buckle 120 to the disengaged configuration in order to allow retraction of the elongated member 110 through the buckle 120 along the one direction D1 and thereby increase the length of the elongated member 110 between the first and second handcuffs 130, 140. The law enforcement official may use the key 150 (FIG. 5) to adjust the buckle 120 to the disengaged configuration.

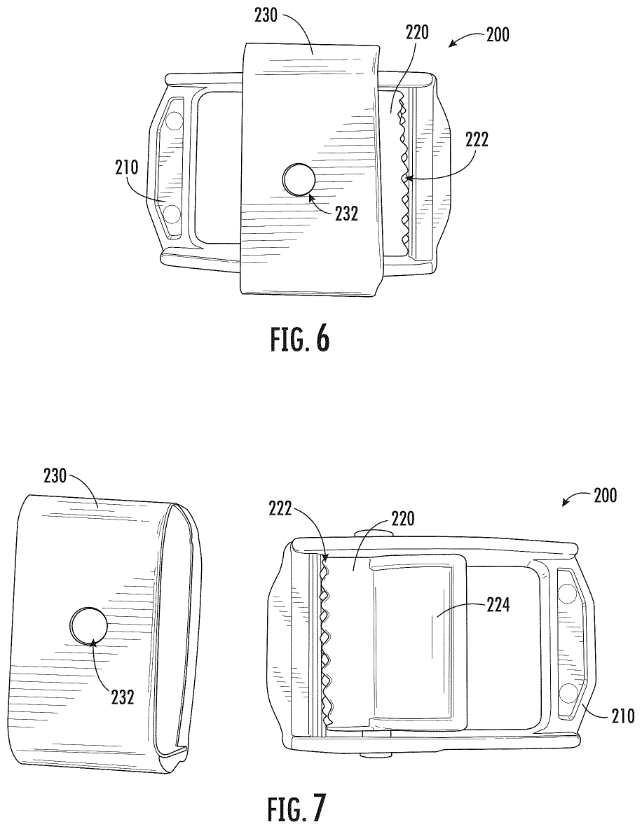

FIGS. 6 and 7 show a buckle 200 according to another example embodiment. The buckle 200 may include a casing 210 and a lever 220 with a knurled surface 222. The buckle 200 may function in similar manner to that described above for buckle 120 (FIGS. 1 through 5). The lever 220 may include a handle 224 for actuating the buckle 200 from the engaged configuration into the disengaged configuration. To prevent an individual secured with the hand restraint system 100 from actuating the lever 220 using the handle 224, the buckle 200 may include a cover 230 that is disposed over the lever 220. The cover 230 may limit or prevent the individual secured with the hand restraint system 100 from pushing on the handle 224 with his or her fingers in order to allow for retraction of the elongated member 110 through the cam buckle 120 in the one direction D1. To allow the law enforcement officer to shift the buckle 200 from the engaged configuration into the disengaged configuration, the cover 230 may include a keyhole 232, and the law enforcement officer may insert a key through the keyhole 232 in order to press against the handle 224 and shift the lever 220 such that the elongated member 110 is movable through the buckle 200 in the one direction D1 in order to increase the length of the elongated member 110 between the first and second handcuffs 130, 140.

As may be seen from the above, the first and second handcuffs 130, 140 may each be applied or positioned on a wrist of an individual. By providing two handcuffs and the buckle, a user may have various options for applying the hand restraint system 100 to wrists of the individual. Thus, the hand restraint system 100 may provide a flexible system for controlling and securing an individual's wrists. Moreover, the hand restraint system 100 is a useful tool for a law enforcement official, and the hand restraint system 100 may assist the law enforcement official with safely and quickly restraining non-compliant individuals. The hand restraint system 100 may be conveniently carried on a belt of the law enforcement official, e.g., as a supplement to a conventional set of handcuffs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A hand restraint system, comprising:
an elongated member extending between a first end portion and a second end portion, the elongated member comprising a first handle and a second handle, the first handle disposed at the first end portion of the elongated member, the second handle disposed at the second end portion of the elongated member;
a buckle mounted on the elongated member between the first and second end portions of the elongated member; and
a first handcuff and a second handcuff, the first handcuff mounted to the elongated member at the first end portion of the elongated member, the second handcuff mounted to the buckle,
wherein the buckle is coupled to the elongated member such that a length of the elongated member between the first and second handcuffs is adjustable.

2. The hand restraint system of claim 1, wherein the hand restraint system includes only two handcuffs.

3. The hand restraint system of claim 1, wherein a length of the elongated member between the first end portion and the second end portion of the elongated member is no less than eight inches and no more than sixteen inches.

4. The hand restraint system of claim 1, wherein the elongated member comprises a webbing.

5. The hand restraint system of claim 1, wherein:
each of the first and second handcuffs respectively comprise a first strand rotatably mounted to a second strand with a hinge;
the first strand of the first handcuff is attached to the elongated member at the first end portion of the elongated member; and
the first strand of the second handcuff is attached to the buckle.

6. The hand restraint system of claim 5, wherein:
each of the first and second handcuffs respectively comprise a swivel on the first strand;
the first end portion of the elongated member is attached to the first strand of the first handcuff at the swivel of the first handcuff; and
the buckle is attached to the first strand of the second handcuff at the swivel of the second handcuff.

7. The hand restraint system of claim 1, wherein the first handle comprises a first loop formed by the elongated member.

8. The hand restraint system of claim 7, wherein the second handle comprises a second loop formed by the elongated member.

9. The hand restraint system of claim 1, wherein the buckle comprises a cam buckle.

10. The hand restraint system of claim 9, wherein the cam buckle is configured to releasably engage the elongated member such that retraction of the elongated member through the cam buckle is blocked in one direction.

11. The hand restraint system of claim 10, wherein:
the cam buckle is configured such that increasing of the length of the elongated member between the first and second handcuffs is blocked when the cam buckle engages the elongated member; and
the cam buckle is configured such that the elongated member is movable through the cam buckle in another direction that is opposite the one direction in order to decrease the length of the elongated member between the first and second handcuffs when the cam buckle engages the elongated member.

12. The hand restraint system of claim 10, further comprising a key configured to disengage the cam buckle such that the elongated member is retractable through the cam buckle in the one direction.

13. The hand restraint system of claim 10, wherein the cam buckle comprises a lever with a knurled surface, the cam buckle further comprising a cover disposed around the lever.

14. The hand restraint system of claim 1, wherein the first handcuff is fixed relative to the first handle, and the second handcuff is movable relative to the first handle.

15. A hand restraint system, comprising:
an elongated member extending between a first end portion and a second end portion, the elongated member comprising a handle at the second end portion of the elongated member;
a buckle movably mounted on the elongated member, the buckle adjustable between an engaged configuration and a disengaged configuration, the buckle blocking retraction of the elongated member in one direction when the buckle is in the engaged configuration, the elongated member retractable through the buckle in the one direction when the buckle is in the disengaged configuration; and
a first handcuff and a second handcuff, the first handcuff mounted to the elongated member at the first end portion of the elongated member, the second handcuff mounted to the buckle.

16. The hand restraint system of claim 15, wherein:
the hand restraint system includes only two handcuffs; and
a length of the elongated member between the first end portion and the second end portion of the elongated member is no less than eight inches and no more than sixteen inches.

17. The hand restraint system of claim 15, wherein:
each of the first and second handcuffs respectively comprise a first strand rotatably mounted to a second strand with a hinge;
the first strand of the first handcuff is attached to the elongated member at the first end portion of the elongated member; and
the first strand of the second handcuff is attached to the buckle.

18. The hand restraint system of claim 15, wherein the handle comprises a loop formed by the elongated member.

19. The hand restraint system of claim 15, wherein:
the buckle comprises a cam buckle;
the cam buckle is configured such that increasing of a length of the elongated member between the first and second handcuffs is blocked when the cam buckle is in the engaged configuration; and
the cam buckle is configured such that the elongated member is movable through the cam buckle in another direction that is opposite the one direction in order to decrease the length of the elongated member between the first and second handcuffs when the cam buckle is in the disengaged configuration.

20. The hand restraint system of claim 19, further comprising a key configured to disengage the cam buckle such that the elongated member is retractable through the cam buckle in the one direction.
